(19) United States
(12) Patent Application Publication
(10) Pub. No.: US 2016/0222992 A1
(43) Pub. Date: Aug. 4, 2016

(54) Brake Cylinder

(71) Applicant: Knorr-Bremse Systeme fuer Nutzfahrzeuge GmbH, Muenchen (DE)

(72) Inventors: Huba NEMETH, Budapest (HU); Gabor SZUECS, Kecskemet (HU); Csaba MLINARCSEK, Budapest (HU)

(21) Appl. No.: 15/094,378

(22) Filed: Apr. 8, 2016

Related U.S. Application Data
(63) Continuation of application No. PCT/EP2014/071717, filed on Oct. 10, 2014.

(30) Foreign Application Priority Data
Oct. 11, 2013 (DE) 10 2013 016 890.2

(51) Int. Cl. F15B 15/10; B60T 17/08

(52) U.S. Cl. CPC F15B 15/10; B60T 17/081

(57) ABSTRACT

A brake cylinder of a vehicle brake is provided. The brake cylinder includes a brake cylinder housing having a housing upper part and a housing lower part (4), a diaphragm annularly captured between the housing parts, (16), and a clamping ring securing the housing parts together. The clamping ring is formed from clamping ring upper and lower part portions configured to be pressed into latched engagement with the housing upper and lower parts and the diaphragm captured by the clamping ring.

### CROSS REFERENCE TO RELATED APPLICATIONS

This application is a continuation of PCT International Application No. PCT/EP2014/071717, filed Oct. 10, 2014, which claims priority under 35 U.S.C. §119 from German Patent Application No. 10 2013 016 890.2, filed Oct. 11, 2013, the entire disclosures of which are herein expressly incorporated by reference.

### BACKGROUND AND SUMMARY OF THE INVENTION

The present invention relates to a brake cylinder for a vehicle brake, in particular for the brakes of a commercial vehicle.

Brake cylinders of this kind are known in relevant forms in the prior art.

A conventional wheel brake for a vehicle comprises, inter alia, a service brake by which a braking force required for braking the vehicle when driving is produced. Especially when it is pneumatically actuated, a service brake has a brake cylinder which produces the service brake application force via a brake caliper. The brake cylinder includes a piston rod which acts, for example, on a linkage to actuate the brake. According to the prior art, a brake cylinder generally has at least two housing parts, wherein both housing parts are clamped together with a diaphragm serving as a piston by a clamp to form the brake cylinder housing with the integrated diaphragm or piston.

U.S. patent publication no. U.S. Pat. No. 2,541,205 A1 discloses a one-piece clamp which clamps two tubular or cylindrical components together in a fluidtight manner. For this purpose, the two ends of the tubular or cylindrical components each have a wedge-shaped thickened portion or wedge-shaped collar on their side facing the clamp. Together, the two collars form a cross section in the form of a V belt, over which the clamp according to the invention engages. The clamp is designed as a screw clamp, i.e. the clamping force of the clamp is produced nonpositively by means of a screw/nut joint arranged tangentially in relation to the circumference.

U.S. Pat. No. 4,960,036 discloses a clamp divided into two in a radial direction, by which the housing halves of a brake cylinder and a diaphragm are clamped together. On their open sides, the housing halves each have a collar or a thickened portion. The clamping force of the two-part clamp is produced nonpositively by two screw/nut joints each arranged tangentially in relation to the circumference.

U.S. patent no. U.S. Pat. No. 5,193,432 A furthermore discloses a one-piece clamp, with which the intention is to provide a tamperproof brake cylinder. The clamp is produced nonpositively by a radially arranged screw/nut joint.

In each case, the disadvantage with the abovementioned prior art is that the respectively disclosed clamp does not completely surround the two housing components since, by virtue of its operation, a gap must be left between the ends of the clamp in order to produce an appropriate clamping force. This produces a discontinuous force profile which is nonuniform over the entire circumference of the clamp. The clamped components are therefore subject to surface pressures which are of considerable magnitude locally and are at least not conducive to the service life of the components. Moreover, a screw/nut joint takes up a considerable amount of installation space, which is often not unlimited in the restricted installation space zones of a brake cylinder.

In addition, U.S. patent publication no. US 2007/0017757 A1 presents a tamperproof spring cylinder in which two housing parts and a diaphragm are clamped together. The clamping force required for this is produced positively by snap hooks, which are arranged in a pattern on the circumference of one of the two housing parts. The snap hooks latch into corresponding depressions arranged in the other housing part to be clamped. In the solution disclosed in U.S. patent publication no. US 2007/0017757 A1, there is no explicit mention of a clamp or additional parts that produce the clamping function.

The disadvantage with the solution according to U.S. patent publication no. US 2007/0017757 A1 is the integration of the clamping function into the housing ends. To achieve this, at least one housing part has to be produced from a material with good forming characteristics. Moreover, the solution disclosed requires a complex assembly method and tool. Owing to the geometry at the housing end of at least one housing part, tight forming radii are required, which can lead to microcracks in the surface protection coating, in which case there is therefore the risk of the premature onset of corrosion.

It is therefore the underlying object of the invention to provide a brake cylinder which at least partially overcomes the abovementioned disadvantages.

In a particularly preferred embodiment of the invention, the positive clamped joint is implemented in a manner which is simple in terms of design by the latching of a clamping ring on the housing upper side and a clamping ring on the housing lower side.

In another preferred embodiment of the invention, the clamping ring associated with the housing lower part has openings, wherein the openings are arranged uniformly in a regular pattern on the circumference of the clamping ring associated with the housing lower part, with the result that an opening advantageously alternates with a circumferential portion without an opening.

In another preferred embodiment of the invention, the clamping ring associated with the housing upper part has snap hooks, wherein the snap hooks are arranged uniformly in a regular pattern on the circumference of the clamping ring associated with the housing upper part, with the result that a snap hook alternates with a circumferential portion without a snap hook in a structurally simple manner.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a section through a brake cylinder according to an embodiment of the invention;

FIG. 2 shows an enlarged detail in section of the brake cylinder according to FIG. 1;

FIG. 3 shows a three-dimensional view of a brake cylinder according to an embodiment of the invention;

FIG. 4 shows an exploded view of a brake cylinder according to an embodiment of the invention, wherein the exploded view is limited to the housing components and a diaphragm.

### DETAILED DESCRIPTION OF THE DRAWINGS

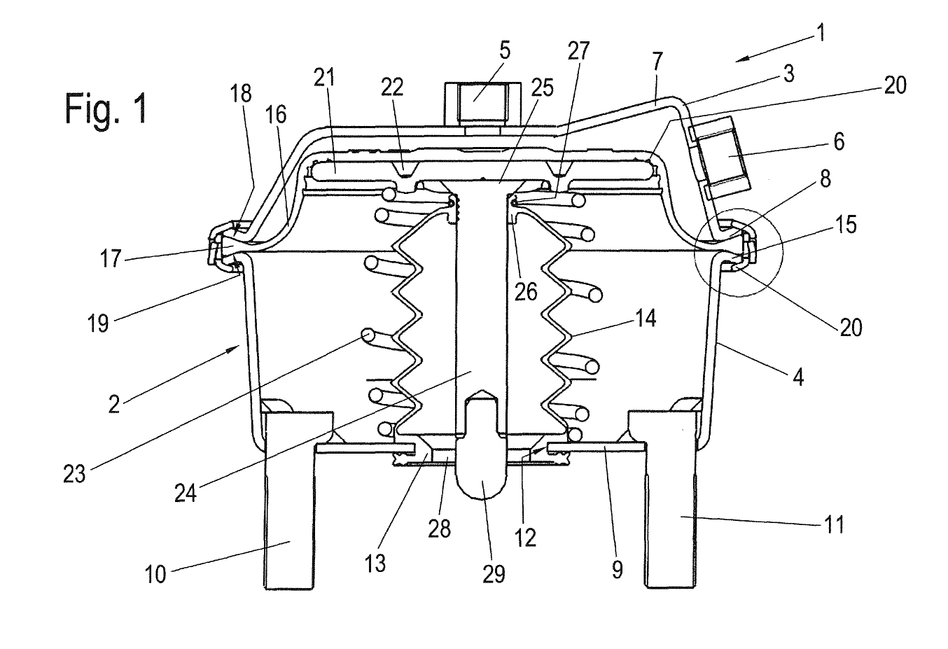

A brake cylinder 1 is shown fully in section in FIG. 1. The brake cylinder 1 has a brake cylinder housing 2, which is divided into a housing upper part 3 and a housing lower part 4.

The housing upper part 3 has a frustoconical basic geometry and, during the operation of the brake cylinder 1, is supplied with a pressurized fluid. The brake cylinder 1 is operated with compressed air as the fluid.

The housing upper part 3 furthermore has fluid-line connections 5, 6 for supplying the brake cylinder with fluid. In order to provide a plurality of possible connections in the case of problems with installation space, one fluid-line connection 5 is implemented vertically on the end face and the other fluid-line connection 6 is implemented horizontally by a protrusion 7 on the housing upper part 3. Since, insofar as the brake cylinder 1 is operated with a gaseous fluid—e.g. compressed air—it is operated as a single-acting cylinder, one fluid-line connection 5, 6 in each case is supplied by the fluid inlet line (not shown), while the other fluid-line connection 5, 6 in each case is provided with a vent (not shown). Moreover, the housing upper part 3 has an encircling collar 8 on its upper side.

The housing lower part 4 has a housing bottom 9. The housing bottom 9 has at least two securing means, here embodied as threaded bolts 10, 11—purely by way of example—by which the brake cylinder 1 is secured on a brake (not shown). Here, by way of example, the threaded bolts 10, 11 are secured on the housing bottom 9 by fusion welding. However, it is also possible to secure the threaded bolts 10, 11 on the housing bottom 9 by some other joining method. The housing bottom 9 furthermore has an opening 12. Inserted into the opening 12 is a seal 13, which forms a sealing bellows 14 in the vertical direction, wherein the sealing bellows 14 extends in the direction of the housing other part 3. Here—purely by way of example—the sealing bellows 14 is designed as a folding bellows. The seal 13 furthermore centers a compression spring 23. The housing lower part 4 furthermore has a collar 15 on its open side.

The brake cylinder 1 furthermore has a diaphragm 16. On its outer edge, the diaphragm 16 has a bead 17. The bead 17 has a wedge-shaped basic cross section, wherein the wedge flanks 18, 19 of the bead hug the respective collars 8, 15 of the housing upper part 3 and the housing lower part 4, thus producing a sealing function between the housing upper part 3 and the housing lower part 4. The diaphragm 16 has a plurality of annular depressions 20, which are used to center a pressure plate 21. The diaphragm 16 is preferably produced from a rubber-elastic material.

The pressure plate 21 has a circular groove 22, by which a compression spring 23 is centered and/or positioned in the housing upper part 3. Purely by way of example here—the compression spring 23 has a circular wire cross section and—likewise purely by way of example—a barrel-shaped basic geometry. In the single-acting brake cylinder 1, the compression spring 23 brings about the return of a piston rod 24. At its end associated with the housing upper part, the piston rod 24 forms a conical head 25 and rests by the conical head 25 against the pressure plate 21. At its end associated with the housing upper part, the sealing bellows 14 forms a sealing bead 26, wherein the sealing bead 26 is fixed under the conical head 25 of the piston rod 24 by a clamping ring 27. The piston rod 24 passes through the sealing bellows 24 and a central opening 28 in the seal 13. At its end associated with the housing lower part, the piston rod 24 has a pressure piece 29, which—purely by way of example here—is screwed centrally into the piston rod 24. As an alternative, other joining methods are also possible. In the installed state of the brake cylinder 1, the pressure piece 29 makes contact, for example, with a linkage (not shown), by which a brake (not shown) is applied.

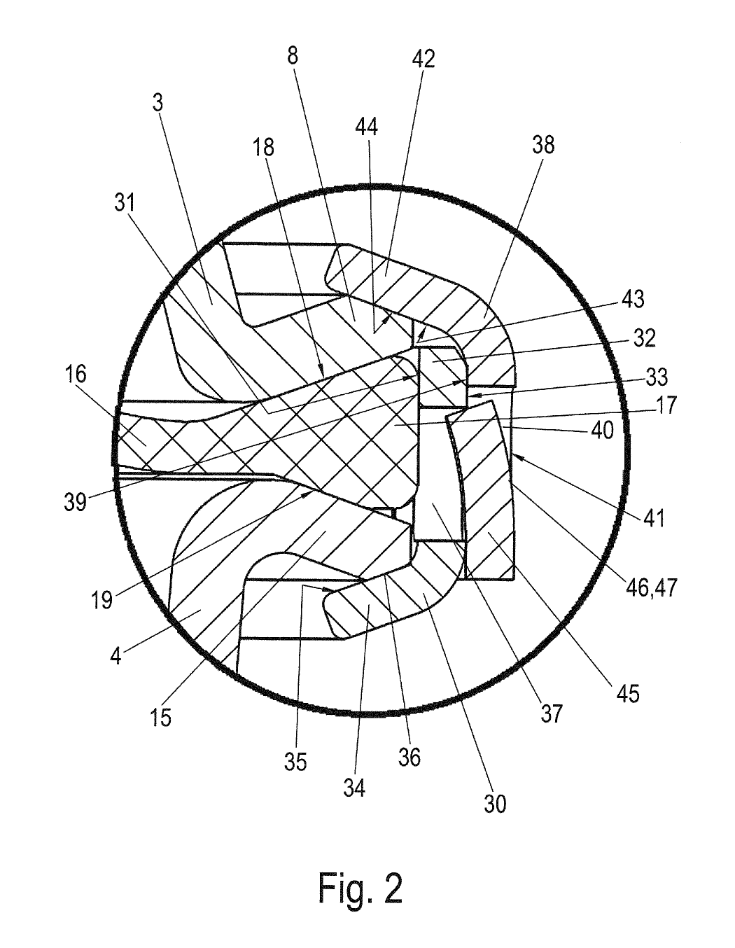

The region of the joint between the bead 17 of the diaphragm 16 and the respective collars 8, 15 of the housing upper part 3 and the housing lower part 4 are readily visible in FIG. 2.

The region of the joint has a clamping ring 30 associated with the housing lower part, said ring having a substantially J-shaped cross section. The inner side 31 of the vertical leg 32 of the clamping ring 30 associated with the housing lower part hugs the outer edge 33 of the bead 17 of the diaphragm 16. The inner side 35 of the angled leg 34 of the clamping ring 30 associated with the housing lower part hugs the collar 15 of the housing lower part 4. For this purpose, the collar 15 has a corresponding flat 36. The clamping ring 30 associated with the housing lower part furthermore has openings 37 in its vertical leg 32. The openings 37 are arranged uniformly in a regular pattern on the circumference of the clamping ring 30 associated with the housing lower part, with the result that an opening 37 alternates with a circumferential portion without an opening 37. The opening 37 preferably has a rectangular cross section. The dimensions of the openings 37 are preferably the same for all the openings 37 situated on the circumference of the clamping ring 30 associated with the housing lower part.

The region of the joint furthermore has a clamping ring 38 associated with the housing upper part, which has a J-shaped cross section rotated substantially through 180° in the installed position. The inner side 39 of the vertical leg 40 of the clamping ring 38 associated with the housing upper side hugs the outer side 41 of the clamping ring 30 associated with the housing lower part. The inner side 43 of the angled leg 42 of the clamping ring 30 associated with the housing upper side hugs the collar 8 of the housing upper part 4. For this purpose, the collar 8 has a corresponding flat 44. The clamping ring 38 associated with the housing upper part furthermore has snap hooks 45 on its vertical leg 40. The snap hooks 45 are arranged uniformly in a regular pattern on the circumference of the clamping ring 38 associated with the housing upper part, with the result that a snap hook 45 alternates with a circumferential portion without snap hooks 45. The snap hook 45 has a geometry and dimensions corresponding to the opening 37.

The snap hook 45 is produced by cutting the vertical leg 40 and then pushing out the tab 46 formed by the cutting process in the direction of the inner side 39 of the vertical leg 40 of the clamping ring 38 associated with the housing upper side. In this case, the free end 47 of the tab 46 is oriented in the direction of the housing upper part 3 and engages in the corresponding opening 37 in the clamping ring 30 associated with the housing lower part.

As a result, the housing upper part 3 and the housing lower part 4 are positioned and fixed one upon the other positively, and the brake cylinder housing 2 is formed, by latching the clamping ring 30 associated with the housing lower part and the clamping ring 38 associated with the housing upper part while simultaneously exerting a clamping or sealing force on the bead 17 of the diaphragm 16.

The snap joint is preloaded by the bead 17 of the diaphragm 16 since the rubber-elastic material pressed in by the housing upper part 3 and the housing lower part 4 exerts a corresponding counterforce on the housing upper part 3 or clamping ring 38 associated with the housing upper part and on the housing lower part 4.

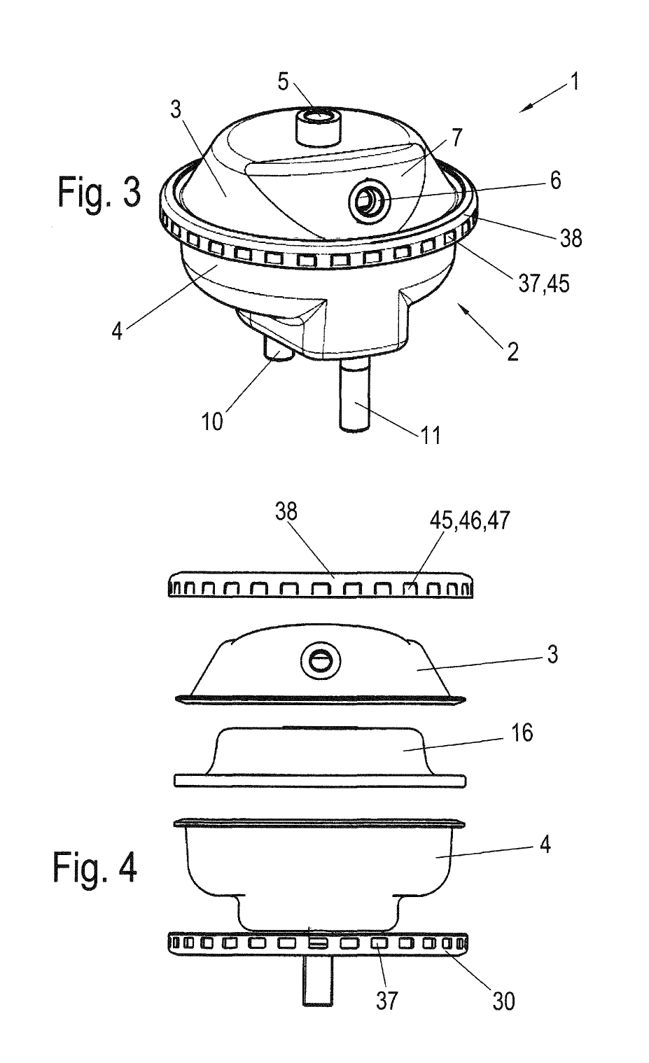

Readily visible in FIG. 3, there are, in particular, the clamping ring 38 associated with the housing upper part and the tabs 46 thereof, which are arranged in a regular pattern on the circumference of its vertical leg 40, and the protrusion 7 of the housing upper part 3.

A method of assembling the housing components 3, 4, 30, 38 and the diaphragm 16 is shown in FIG. 4. Components which are situated or arranged in the interior of the housing after assembly are not shown for greater clarity, and are also not mentioned or dealt with explicitly. It is assumed below that the housing upper part 3 and the housing lower part 4 are each preinstalled in the interior of the housing with all components required for the operation of the brake cylinder 1.

First of all, the clamping ring 30 associated with the housing lower part and the housing lower part 4 are provided and placed on a fixed annular support (not shown).

Here, the housing lower part 4 rests by the flat 36 thereof on the inner side 35 of the angled leg 34 of the clamping ring 30 associated with the housing lower part. On the other hand, the clamping ring 30 associated with the housing lower part rests by its angled leg 34 on the fixed annular support, which can be designed as the lower part of an assembly tool, for example.

In a further step, the diaphragm 16 is placed on the collar 15 of the housing lower part 4, and the housing upper part 3 is then placed by its collar 8 on the diaphragm 16.

In a final step, the clamping ring associated with the housing upper part is then positioned correctly and pressed onto the flat 44 of the housing upper part 3 by a suitable annular tool (not shown) until the free ends 47 of the tabs 46 of the clamping ring 38 associated with the housing upper part, said free ends being designed as snap hooks 45, latch into the openings 37 in the clamping ring 30 associated with the housing lower part.

### LIST OF REFERENCE SIGNS

1 brake cylinder
2 brake cylinder housing
3 housing upper part
4 housing lower part
5 fluid-line connection
6 fluid-line connection
7 protrusion
8 collar
9 housing bottom
10 threaded bolt
11 threaded bolt
12 opening
13 seal
14 sealing bellows
15 collar
16 diaphragm
17 bead
18 wedge flank
19 wedge flank
20 annular depression
21 pressure plate
22 circular groove
23 compression spring
24 piston rod
25 conical head
26 sealing bead
27 clamping ring
28 central opening
29 pressure piece
30 clamping ring associated with the housing lower part
31 inner side
32 vertical leg
33 outer edge
34 angled edge
35 inner side
26 flat
37 opening
38 clamping ring associated with the housing upper part
39 inner side
40 vertical leg
41 outer side
42 angled leg
43 inner side
44 flat
45 snap hook
46 tab
47 free end

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A brake cylinder having a brake cylinder housing, comprising:
a housing upper part;
a housing lower part;
a diaphragm; and
a clamping ring having an upper side portion and a lower side portion,
wherein
the housing upper part includes at least one fluid-line connection,
the housing lower part includes brake mounting devices configured to secure the brake cylinder to a vehicle brake,
clamping ring upper and lower side portions are configured to cooperate with one another to positively claim together the housing upper part, the housing lower part and the diaphragm.

2. The brake cylinder as claimed in claim 1, wherein
the clamping ring upper and lower side portions are configured to latch to one another.

3. The brake cylinder as claimed in claim 2, wherein
the clamping ring upper and lower side portions are J-shaped.

4. The brake cylinder as claimed in claim 3, wherein
each of the J-shaped clamping ring upper and lower side portions includes a vertical leg and an angled leg.

5. The brake cylinder as claimed in claim 4, wherein
the clamping ring lower side portion includes a plurality of openings in the clamping ring lower side portion vertical leg.

6. The brake cylinder as claimed in claim 5, wherein
the plurality of openings are arranged uniformly around a circumference of the clamping ring housing lower part portion such that each of the plurality of openings is located between adjacent circumferential portions of the clamping ring housing lower part portion without an opening.

7. The brake cylinder as claimed in claim 6, wherein
the clamping ring upper part portion includes a plurality of snap hooks on the clamping ring upper side portion vertical leg.

8. The brake cylinder as claimed in claim 7, wherein
the plurality of snap hooks are arranged uniformly on a circumference of the clamping ring upper part portion such that each of the plurality of snaphooks is located between adjacent circumferential portions of the clamping ring housing upper part portion without a snap hook.

9. The brake cylinder as claimed in claim 8, wherein
the plurality of clamping ring upper part portion snap hooks each is configured to engaged a corresponding one of the plurality of clamping ring lower part portion openings.

10. An assembly method for a brake cylinder having a brake cylinder housing, comprising the acts of:
locating a clamping ring lower part portion of a clamping ring on a lower part of the housing;
placing a diaphragm on a collar of the housing lower part;
placing a collar of an upper part of the housing on the diaphragm on a side of the diaphragm opposite the housing lower part;
locating a clamping ring upper part portion of the clamping ring on the housing upper part;
engaging the clamping ring upper and lower part portions together with the housing lower part, housing upper part and diaphragm captured between the clamping ring portions,
wherein the clamping ring upper and lower part portions are engaged together by engaging a plurality of snap hooks of the clamping ring upper part portion into respective ones of a plurality of openings of the clamping ring lower part portion.

11. The assembly method of claim 10, further comprising the act of:
locating the assembled housing lower part and clamping ring lower part portion on an annular support of an assembly tool prior to the act of engaging the clamping ring part portions together.

12. The assembly method of claim 11, wherein
the act of engaging the clamping ring upper and lower part portions together is performed with an annular tool configured to bear onto a flat on the housing upper part until free ends of the plurality of snap hooks latch into the respective ones of the plurality of openings.
